(19) United States
(12) Patent Application Publication
(10) Pub. No.: US 2008/0180670 A1
(43) Pub. Date: Jul. 31, 2008

(54) Lighting device and method for realizing a desired color mixture

(75) Inventor: Carsten Vogel, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 12/011,209

(22) Filed: Jan. 24, 2008

Related U.S. Application Data
(60) Provisional application No. 60/898,649, filed on Jan. 31, 2007.

(30) Foreign Application Priority Data
Jan. 31, 2007 (DE) 10 2007 004 834.5

(51) Int. Cl. G01N 21/25

(52) U.S. Cl. 356/406

(57) ABSTRACT

A device and method for controlling a plurality of individual light sources with varying spectra, wherein a desired resulting light spectrum with three manipulated variables representing a color standard is selected to serve as the basis along with an detected light spectrum to control the plurality of light sources with varying spectra in such a way that at least a part of the plurality of controllable light sources emits a resulting light spectrum that correspond to the desired light spectrum to at least a selectable level of accuracy.

### CROSS-REFERENCE TO RELATED APPLICATIONS

This application claims the benefit of the filing date of U.S. Provisional Patent Application No. 60/898,649 filed Jan. 31, 2007, the disclosure of which is hereby incorporated herein by reference.

The present invention relates to a device and a method for controlling a plurality of light sources, and in particular to a device and a method for controlling a plurality of light sources in such a way that a homogeneous, even and stable color mixture can be realized in different devices.

### BACKGROUND OF THE INVENTION

Color-mixing systems with light-emitting diodes consisting of three diodes are known from prior art. The three diodes can be one red, one green and one blue light-emitting diode, so that properly controlling the diodes can bring about an additive color mixture. Since each individual light-emitting diode (LED) has a very narrow spectrum, it is hardly possible to simulate natural light, since daylight, for example, comprises a broad spectrum comprised of every visible wavelength. Commercially available lighting devices for controlling color-mixing systems use a separate manipulated variable per used color or light component.

Further, the brightness of the diodes changes over the life of the diode, so that the characteristics of the emitted light of the diode change over time. In addition, manufacturing tolerances and ambient temperatures have an influence on the property of the light emitted by the diodes, wherein these tolerances and temperature influences vary depending on color. The effect of this is that a color difference becomes visible despite identical controlling data given the same type of light sources that vary in age.

### SUMMARY OF THE INVENTION

An exemplary embodiment of the invention provides a device for controlling a plurality of light sources having various spectra, with an input device designed to receive a selectable, desired light spectrum, a detecting device designed to detect a light spectrum, and a control device designed to control a plurality of light sources having various spectra based on a desired light spectrum to be selected on the input device and the light spectrum detected by the detecting device, wherein at least a part of the plurality of controllable light sources emits a resulting light spectrum that corresponds with the desired light spectrum at least within a selectable level of accuracy.

This makes it possible not just to actuate light sources, but also to control them based on a detected light spectrum in such a way that the light spectrum of the light sources can be controlled to a selectable, desired light spectrum, even if the properties of the light sources change within certain limits. Further, it is possible to implement a lighting system that takes into account already present light and, as a function of the latter, controls a plurality of light sources in such a way that the sum of already present ambient light and light emitted by the plurality of light sources leads to the selectable, desired light spectrum. Various spectra implies that the spectra comprise a spectral range that differs, but can comprise overlaps in terms of natural and/or artificial partial amounts.

In an exemplary embodiment of the invention, the accuracy can be selected via the possible spectrum of the plurality of controllable light sources.

For example, this approach can be used to select an accuracy corresponding to the perceptive accuracy of the human eye, so that the complexity of the control and regulating systems need only reflect the selected accuracy.

In an exemplary embodiment of the invention, the light spectrum resulting from at least a part of the plurality of light sources at least approximately correspond with the desired light spectrum.

In this way, the desired light spectrum can actually be realized.

In an exemplary embodiment of the invention, the detecting device comprises a first detecting unit designed to detect light emittable from one of the controlled light sources.

Therefore, such a first detecting unit in the detecting device permits a direct feedback of the light emitted by the light sources, so as to thereby compensate for ageing or temperature phenomena and a resultant deviation of the emitted light color and intensity over time, for example.

In an exemplary embodiment of the invention, the first detecting unit comprises a plurality of current, voltage or power meters, which are provided in the controlling lines of the light sources.

In this way, for example, the measured variables can be converted into a resulting intensity of the light emitted by the corresponding light source, so as to in this way prevent outside light from causing the first detecting unit to perform a faulty detecting process.

In an exemplary embodiment of the invention, the detecting device comprises a second detecting unit designed to detect light not originating from the source itself.

Such a second detecting unit can take into account the ambient light for a controlling process, so that lighting can be effected not just using the light emitted by the light source, but also based upon an already present ambient light. As a result, an actual light process can be controlled with consideration of light parts stemming from both a light sources accessible to the controlling device and light parts stemming from other light sources.

In an exemplary embodiment of the invention, the second detecting device comprises a color light sensor designed to detect a spectrum of the ambient light.

Such a color light sensor makes it possible to detect essentially the complete scope of the spectrum of the ambient light, so that a lighting system can be controlled and/or regulated based hereupon. As a result, the spectrum of the predominant ambient light can be included in the control process, e.g., if the latter already comprises a certain color nuance.

In an exemplary embodiment of the invention, the control device comprises a reference table that incorporates a correlation between a desired light spectrum, a light spectrum detected by the detecting device and corresponding controlling signals based on which the light sources can be controlled.

Such a reference table permits a rapid access and quick controlling, and also offers a simple way to update, in particular if the majority of light sources are controlled based on two parameters, here for example the desired light spectrum and a light spectrum detected by the detecting device. Such a reference table can be present in the form of a file or file group.

In an exemplary embodiment of the invention, the control device has implemented an algorithm based upon which controlling signals can be generated for the light sources, wherein the algorithm is a function of a desired light spectrum and a light spectrum detected by the detecting device.

An algorithm usually provides an elegant tool with which functional correlations can be represented also as a function of more than one parameter with a relatively low memory outlay, here for example the two parameters desired light spectrum and light spectrum detected by the detecting device.

In an exemplary embodiment of the invention, the input device is designed to receive input variables relating to a CEI color system.

only two variables need be used with a CEI color system or in a CEI color space to determine a color in a color plane that represents not just a mixture of discrete colors, e.g., as in an RGB system. A third variable can be used to indicate the intensity. The CEI color space segmentation is modeled to a precise enough extent that the deviations are no longer discernible with the human eye.

In an exemplary embodiment of the invention, the light sources are controlled via pulse width modulation with a variable pulse width. The pulse width can be adjusted. The variable pulse width makes it possible to offset differences in diode characteristics for various LED's, thereby enabling a flicker-free dimming even in the lower brightness ranges.

In an exemplary embodiment of the invention, the control device is designed to control at least four light sources, each with respectively different dominant wavelengths.

A more precise image of a natural color can be obtained in this way, in particular in the white light range, thereby enabling a more realistic rendition, e.g., of daylight. Other than the already known colors red, green and blue, use can also be made of the color amber. Of course, it is possible to use as many other colors comprising a desired overall spectrum when taken together.

An exemplary embodiment of the invention provides one or more transformation devices designed to transform the color spaces or color system in which the light spectrum is respectively present at the input device, the detecting device and the control device.

As a result, use of the device according to the invention is not limited to processing a specifically selected color system; rather, the device can also be used for displaying the selection of the desired light spectrum and a detected light spectrum in varying color systems or color spaces.

In an exemplary embodiment of the invention, an aircraft with a device according to the invention is provided.

In an exemplary embodiment of the invention, a method is provided for controlling a plurality of light sources with varying spectra, comprising receiving of a selectable, desired light spectrum, detecting of a light spectrum, and controlling of a plurality of light sources with varying spectra based on the selectable, desired light spectrum and the detected light spectrum in such a way that at least a part of the plurality of controllable light sources emits a resulting light spectrum that at least corresponds with the desired light spectrum to within an accuracy selectable by the sources and algorithm.

An exemplary embodiment of the invention provides a program element that implements the method according to the invention when incorporated on a processor.

An exemplary embodiment of the invention provides a computer-readable storage medium holding the program element according to the invention.

It should be noted that the exemplary embodiments of the invention described above and below relate to the method, the device, the program element and the computer-readable storage medium, correspondingly.

Further, it should be noted that the individually described features can also be combined with each other.

These and other aspects of the present invention with become clear and explained with reference to the embodiments described below.

### BRIEF DESCRIPTION OF THE DRAWINGS

Exemplary embodiments of the invention will be described below with reference to the following drawings.

FIG. 1 is a schematic view of a device according to an exemplary embodiment of the invention.

FIG. 2 is a schematic view of another embodiment of the device according to the invention.

FIG. 3 is a schematic flowchart for a method according to the present invention.

### DETAILED DESCRIPTION

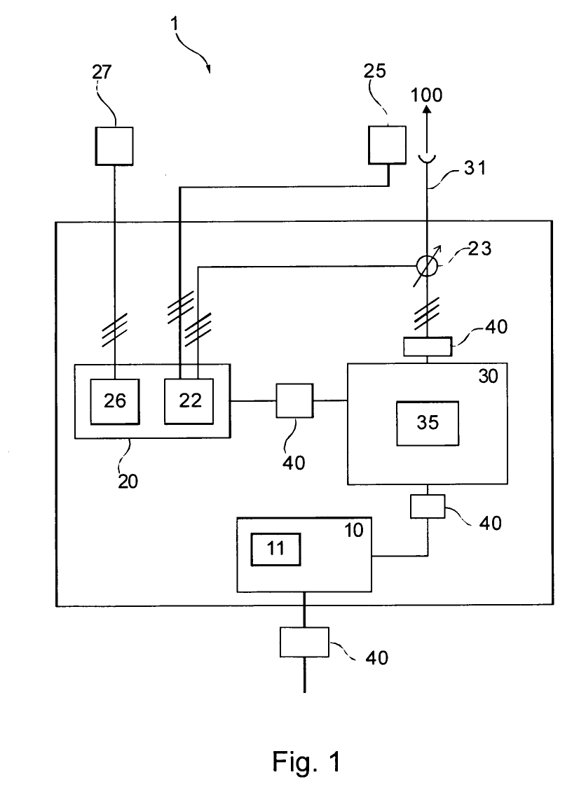

FIG. 1 shows an exemplary embodiment of a device according to the present invention.

The device 1 is a device for controlling a plurality of light sources 100 with varying spectra. The device 1 comprises an input device 10, which is able to receive a selectable, desired spectrum. The input device 10 can here comprise a temporary storage 11 to store a sequence of selectable, desired light spectra and relay them to a control device 30. Further, the device 1 comprises a detecting device 20 provided to detect a color spectrum. The detecting device 20 provides information about a detected color spectrum to a control device 30 also provided in the device 1. Based on the selectable, desired light spectrum and a detected light spectrum, the control device can now control a plurality of light sources 100 in such a way that the light sources 100 emit a resulting light spectrum that corresponds with the desired light spectrum at least within a selectable level of accuracy. Controlling here takes place via controlling lines 31. It should be noted that each of the lines shown on FIG. 1 can also be designed as a line with several channels, in particular when a plurality of light sources is being controlled. The plurality of channels can be realized using several multi-lead lines, but also by providing several channel frequencies or channel time slots.

The detecting device can comprise a first detecting unit 23, 25, which detects the spectrum of a light emitted by the light sources 100. This can take place, for example, using a plurality of current, voltage or power meters 23 (depending on the type of used LED), which are provided in the respective controlling lines 31 for the individual light sources 100, but also via an external sensor 25, for example situated close to the individual light sources. The sensor 25 can here be designed in such a way as to detect the resulting light spectrum of the plurality of light sources 100. Additional subsensors can also be provided, e.g., which each detect a partial spectrum of a specific one of the plurality of light sources 100, or a spectrum of a part of the light sources 100.

Further, the detecting device comprises a second detecting unit 26 designed to detect the spectrum of an ambient light. For example, this can take place via a light sensor 27. As with sensor 25, the light sensor 27 can comprise subsensors with the subfunctions specified above.

It should be noted that it is not absolutely necessary to detect the ambient light if, for example, the ambient light is largely known or not relevant in terms of adjusting the lighting system. It should further be noted that the light spectrum of the plurality of light sources can be detected either via just the current meters 23 or just the sensor 25, or via both the current meters 23 and the sensor.

For example, the control device 30 comprises a reference table 35 that incorporates the correlation between the selectable, desired light spectrum, a detected ambient light, the light emitted by the light sources and corresponding control signals in order to ensure optimal controlling of the light sources 100. Of course, a reference table may comprise only a part of the parameters indicated above. The reference table can be present in the form of a file or file group. Preparation can involve a single configuration or additional updates. This can occur both online.

Additionally or alternatively, an algorithm can be implemented in the control device 30, representing the controlling signals as a function of the desired light spectrum and the detected light spectrum (ambient light and light sources). The same as for the reference table holds true with respect to configuration and updating.

The device can further comprise transformation device 40, which can transform information relating to the spectrum or color into various color spaces or color systems, so that the device 1 can also be used for applications with different present color systems or color spaces. The transformation device can be functionally provided upstream or downstream from the corresponding unit, but also centrally located, e.g., when all transformation work is performed through a single transformation device, for example, in the time slot process.

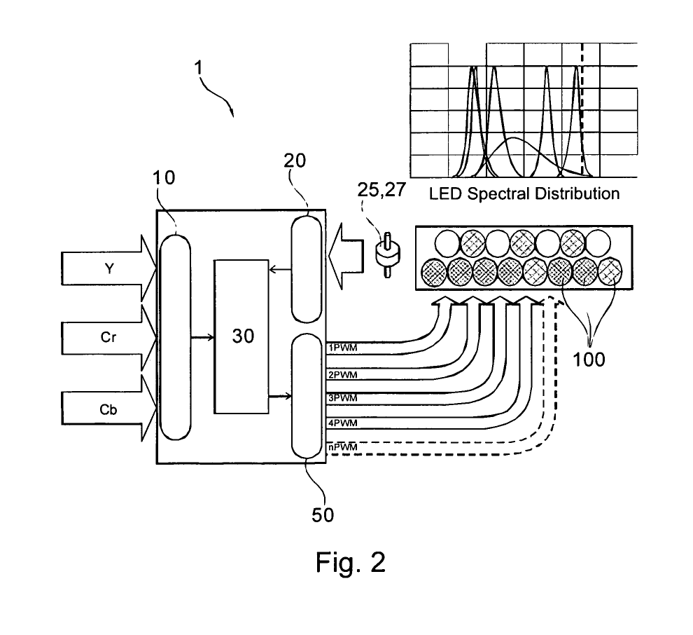

FIG. 2 shows an exemplary embodiment of the invention in which the device 1 comprises a control device 30. In the embodiment depicted on FIG. 2, an input device 10 receives a signal of a CEI color system, in which the three variables Y, Cr and Cb are used to select the intensity as well as the color in the color space that is desired for lighting purposes. The controller 30 processes this input information along with the information provided by a color sensor 25, 27 via a detecting device 20, and releases control signals to an output 50. The plurality of light sources 100 is controlled via pulse width modulation (for example, with a variable pulse width adjusted to the connected light sources). A larger number of different controlling signals can here be used, in particular if four or more light sources are controlled, each comprising a different color spectrum. This makes it possible to achieve a more realistic representation of light, in particular when rendering daylight.

This type of arrangement makes it possible to control any light sources without having to the spectral characteristics of each beforehand, since the device detects the light of the light sources for controlling a plurality of light sources, thereby building up a control circuit that adjusts the individual light sources to various intensities, and hence to resulting colors or then to the resulting mixed spectrum, which is selected with the input device 10. It may here indeed happen that the plurality of light sources 100 do not completely cover the desired spectrum, but a rendition is here achieved that reflects the desired color spectrum to a selectable level of accuracy, provided light source is able to fundamentally render this color spectrum.

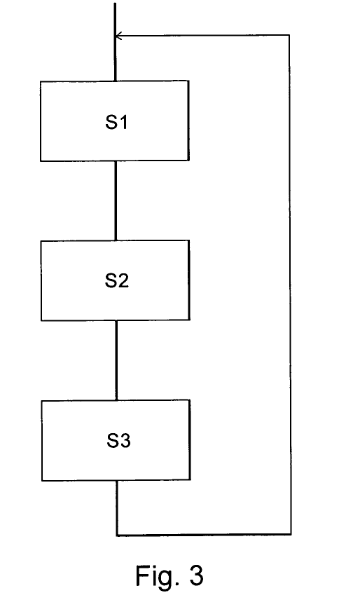

FIG. 3 shows a flowchart for a method according to an exemplary embodiment of the invention.

The method here comprises varying individual steps, in particular receiving S1 of a selectable, desired light spectrum, detecting S2 of a light spectrum and controlling S3 of a plurality of light sources with varying spectra based on the selectable, desired light spectrum and the detected light spectrum in such a way that at least a part of the plurality of controllable light sources emits a resulting light spectrum that corresponds with the desired light spectrum to at least a selectable level of accuracy. It should here be noted that steps S1 and S2 can also occur parallel or in reverse sequence, to subsequently control the plurality of light sources in procedural step S3 on this basis. The method can be iteratively repeated, wherein the iteration depends on what changes are expected in the light sources. For example, the method or device can be used to implement a readaptation or readjustment given a failure of individual light sources, so that the still remaining light sources produce an optimal rendition or lighting that matches the specified parameters to the greatest extent possible. In such a case, the iteration is provided in very short time increments. Iteration in short time intervals makes sense even given expected changes owing to variable operating temperatures. If only an adaptation to replaced elements is to occur, the described steps need only be executed once during startup to essentially calibrate the system. However, another iteration may here be necessary if a desired accuracy is only achieved after several control loop passes.

It should further be noted that controlling can also take place chronologically parallel to a receiving or detecting, for example if information is already detected for the next controlling pass during the control or regulation process, in particular if a quick controlling is required.

It should be noted that the subject matter of the present invention makes it possible in particular to also replace older lighting devices with modern lighting devices having a more optimal light quality without changing the controlling system. In addition, old and new lighting devices can be operated in parallel, since a corresponding calibration is possible that causes the light emitted by the old lighting devices to essentially be perceived in the same way as the light emitted by the modern lighting devices. An integrated color control circuit can here resolve problems involving degradation.

The light quality and color representation of different lighting devices can be held constant for the duration of the service life with the present invention. A downward compatibility of modern devices with old controlling systems is also conceivable.

Lighting devices with a more complex design can also be controlled with only three manipulated variables (previously RGB, in future RGB+white+amber, etc.), specifically with the old input parameters.

It should be noted that the subject matter of this invention can be used in all applications requiring an optimized rendering of colors and light. In particular, the latter can be used in transport equipment with a relatively long service life, for example in aircraft, to still be able to achieve a uniform and homogeneous color and light rendition, e.g., in a passenger cabin, even after light sources are replaced years later.

It should be noted that the term “comprising” does not preclude other elements or steps, and that “a” or “an” does not preclude a plurality.

It should further be noted that the reference numbers in the claims are not to be regarded as a limited protective scope.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A device for controlling a plurality of light sources having various spectra, comprising:
an input device;
a detecting device; and
a control device;
wherein the input device is designed to receive a selectable, desired light spectrum;
wherein the detecting device is designed to detect a light spectrum; and
wherein the control device is designed to control a plurality of light sources having various spectra based on a desired light spectrum to be selected on the input device and the light spectrum detected by the detecting device, in such a way that at least a part of the plurality of controllable light sources emits a resulting light spectrum that corresponds with the desired light spectrum at least within a selectable level of accuracy.

2. The device of claim 1, wherein the accuracy can be selected via the possible overall spectrum of the plurality of controllable light sources.

3. The device of claim 1, wherein the light spectrum resulting from at least a part of the plurality of light sources at least approximately corresponds with the desired light spectrum.

4. The device of claim 1, wherein the detecting device comprises a first detecting unit designed to detect light emitted by the controlled light sources.

5. The device of claim 4, wherein the first detecting unit comprises a plurality of current meters, which are provided in the controlling lines of the light sources.

6. The device of claim 1, wherein the detecting device comprises a second detecting unit designed to detect ambient light.

7. The device of claim 6, wherein the second detecting unit comprises a color light sensor designed to detect a spectrum of the ambient light.

8. The device of claim 1, wherein the control device comprises a reference table that incorporates a correlation between a desired light spectrum, a light spectrum detected by the detecting device and corresponding controlling signals based on which the light sources can be controlled.

9. The device of claim 1, wherein the control device has implemented an algorithm based upon which controlling signals can be generated for the light sources, wherein the algorithm is a function of a desired light spectrum and a light spectrum detected by the detecting device.

10. The device of claim 1, wherein the input device is designed to receive input variables relating to a CEI color system

11. The device of claim 1, wherein the light sources are controlled via pulse width modulation.

12. The device of claim 1, wherein the control device is designed to control at least four light sources with varying spectra.

13. The device of claim 1, wherein a transformation device is provided to transform the color spaces or color systems in which the light spectrum is respectively present at the input device, the detecting device and the control device.

14. An aircraft comprising a device for controlling a plurality of light sources having various spectra, the device comprising:
an input device;
a detecting device; and
a control device;
wherein the input device is designed to receive a selectable, desired light spectrum;
wherein the detecting device is designed to detect a light spectrum; and
wherein the control device is designed to control a plurality of light sources having various spectra based on a desired light spectrum to be selected on the input device and the light spectrum detected by the detecting device, in such a way that at least a part of the plurality of controllable light sources emits a resulting light spectrum that corresponds with the desired light spectrum at least within a selectable level of accuracy.

15. A method for controlling a plurality of light sources having various spectra, comprising:
receiving a selectable, desired light spectrum;
detecting a light spectrum; and
controlling a plurality of light sources with varying spectra based on the selectable, desired light spectrum and the detected light spectrum in such a way that at least a part of the plurality of controllable light sources emits a resulting light spectrum that at least corresponds with the desired light spectrum to within an accuracy selectable by the sources and algorithm.

16. A computer-readable storage medium having stored thereon a program for causing a processor to control a plurality of light sources having various spectra, wherein the program causes the processor to:
receive a selectable, desired light spectrum;
detect a light spectrum; and
control a plurality of light sources with varying spectra based on the selectable, desired light spectrum and the detected light spectrum in such a way that at least a part of the plurality of controllable light sources emits a resulting light spectrum that at least corresponds with the desired light spectrum to within an accuracy selectable by the sources and algorithm.
